(19) United States
(12) Patent Application Publication
(10) Pub. No.: US 2014/0154809 A1
(43) Pub. Date: Jun. 5, 2014

(54) CHANNEL ALLOCATION CONTROL METHOD FOR MULTICHANNEL BIOCHEMISTRY ANALYZER

(71) Applicants: Xingkai Hou, Zhenzhen (CN); Peiwu Gao, Zhenzhen (CN)

(72) Inventors: Xingkai Hou, Zhenzhen (CN); Peiwu Gao, Zhenzhen (CN)

(21) Appl. No.: 13/696,901

(22) PCT Filed: May 9, 2012
(86) PCT No.: PCT/CN2012/075243

§ 371 Date: Nov. 8, 2012

(30) Foreign Application Priority Data
Jul. 1, 2011 (CN) 201110183773.4

(51) Int. Cl. G01N 35/10

(52) U.S. Cl. CPC G01N 35/1009
USPC 436/54

(57) ABSTRACT

The invention provides a channel allocation control method for a multichannel biochemistry analyzer, which comprises the following steps: A. setting the item and the amount of samples to be tested; B. executing aspirating and sampling step simultaneously, in which at least two channels are involved in circular aspirating in aspirating step and circular sampling in sampling step. The channel allocation control method for the multichannel biochemistry analyzer has the advantages that: as the entire test is decomposed into aspirating and sampling step and the circular aspirating and the circular sampling in the two steps are simultaneously and independently executed, not only the aim of testing a plurality of channels simultaneously can be realized and the testing efficiency can be improved but also the channel allocation can be performed automatically and different channels can be identified.

### FIELD OF THE INVENTION

The invention relates to a channel allocation control method, in particular to a channel allocation control method for a multi-channel biochemistry analyzer.

### BACKGROUND OF THE INVENTION

Most of semi-auto biochemistry analyzers over the world are single-channel instruments which not only have extremely low efficiency but also have relatively low automation degree.

As for few multichannel semi-auto biochemistry analyzers in the market, some are only simple assemblies of single-channel instruments, in which channels and items must be manually determined in the test, so the multichannel automatic allocation control cannot be realized and the advantages of multichannel instruments cannot be fully revealed.

### SUMMARY OF THE INVENTION

The invention provides a channel allocation control method for a multichannel biochemistry analyzer in order to solve the problem in the prior art that the multichannel automatic allocation control cannot be realized in a biochemistry analyzer.

The invention provides a channel allocation control method for a multichannel biochemistry analyzer, which comprises the following steps:

A. Presetting the desired test items and the amount of samples;

B. simultaneously carrying out aspirating and sampling step, in which at least two channels are involved in circular aspirating in aspirating step and circular sampling in sampling step.

As the entire test is decomposed into aspirating and sampling step, and the circular aspirating and the circular sampling in the two steps are carried out simultaneously and independently, not only the aim of testing a plurality of channels simultaneously can be realized and the testing efficiency can be improved but also the channel allocation can be performed automatically and different channels can be identified; and as aspirating and sampling are carried out independently and not affected by each other, the sample test can be completed by the collaboration of the two steps.

As a further improvement of the invention, at least two channels are involved (1st channel and 2nd channel), while aspirating step comprises the following steps:

B1. Setting the status of all channels to Idle;

B2. Determining the status of the 1st channel is Idle or not, if yes, carrying out step B3; if not, carrying out aspirating for the 2nd channel;

B3. Starting to aspirate, set the status of the corresponding channel to Occupied and identify the corresponding channel as Aspirating done if aspirating step of the corresponding channel is completed;

B4. Determining whether all the sample items have completed aspirating step. If so, aspirating step is completed; and if not, step B2 is executed.

Aspirating step of the 2nd channel comprises the following procedures:

C1. Determining the status of the 2nd channel is Idle or not, executing step B3 if so, or executing step B2 if not.

Due to the execution of steps B2 and C1, the automatic allocation of the channels is realized, so no channel is required to be determined for aspirating and an Idle channel can be subjected to aspirating automatically, and thus the process is fast and the idle channel can be subjected to aspirating in the shortest time. Therefore, the waiting time of the idle channel can be shortened and the efficiency of channel aspirating can be improved.

As a further improvement of the invention, sampling step comprises the following steps:

D1. Determining the 1^{st} channel have completed aspirating step or not, carrying out step D2 if so; and carrying out sampling step for the 2^{nd} channel if not;

D2. Carrying out sampling for the 1^{st} channel;

D3. Determining whether the required sampling times of the 1st channel on the item is done, executing step D4 if so, or executing Sampling step the 2nd channel if not;

D4. Carrying out data processing and output result for the corresponding channel;

D5. Setting the status of the corresponding channel to Idle;

D6. Determining whether all the samples have completed sampling step, if so, sampling step is completed; and if not, step D1 is executed.

Sampling step of the 2nd channel comprises the following steps:

E1. Determining whether the 2nd channel have completed aspirating step, executing step E2 if so, or executing step D1 if not;

E2. Carrying out sampling for the 2nd channel;

E3. Determining whether the required sampling times on the item has been done, executing step D4 if so, or executing step D1 if not.

Aspirating and sampling step are not only executed independently and not affected by each other but also are interrelated via the set and conversion of the channel status and collaborated with each other to complete the sample test. Therefore, the channels are always in the processes of aspirating and sampling, and thus the speed of sampling can be accelerated.

As a further improvement of the invention, in step D2, whether the waiting time is reached after aspirating the 1st channel is completed is determined, in which the 1st channel is subjected to sampling if, so and Sampling step the 2nd channel is executed if not; and in step E2, whether the waiting time is reached after aspirating step the 2nd channel is completed is determined, in which the 2nd channel is subjected to sampling if so and step D1 is executed if not.

As the sample response speed calculated is different and the test time of different items is different as well, sampling step can only be executed after waiting for a period of time when aspirating step is completed, and then the accuracy of the sample test can be better guaranteed.

As a further improvement of the invention, in step B4, the step for determining whether all the sample items have completed aspirating step comprises the following steps:

B41. setting the amount of the samples to be tested in step A as “a” and the amount of the items to be tested in step A as “b”, in which the total amount of those to be tested is n=a*b;

B42. calculating the amount of the samples to be tested which have not completed aspirating step via the formula n=n−1 when the corresponding channel is identified as a channel having completed aspirating step;

B43. indicating that all the samples to be tested have completed aspirating step when n is zero and that not all the samples to be tested have completed aspirating step if n is not zero.

In step D6, the step for determining whether all the samples have completed sampling step comprises the following steps:

D61. setting the amount of the samples to be tested in step A as “a” and the amount of the items to be tested in step A as “b”, in which the total amount of those to be tested is m=a*b;

D62. calculating the amount of the samples to be tested which have not been completed sampling steps when the corresponding channel has completed sampling step;

D63. indicating that all the samples have completed sampling step when m is zero and that not all the samples have completed sampling step if m is not zero.

As a further improvement of the invention, the number of the channels is four and the four channels are the 1st channel, the 2nd channel, the 3rd channel and the 4th channel respectively; and aspirating step comprises the following steps:

F1. setting the status of all the channels to idle;

F2. determining whether the status of the 1st channel is Idle, executing step F3 if so, or executing aspirating step the 2nd channel if not;

F3. starting to aspirate the corresponding channel, setting the status of the corresponding channel to Occupied, and identifying the corresponding channel as a channel having completed aspirating step after aspirating step the corresponding channel is completed;

F4. determining whether all the sample items have completed aspirating step, in which if so, aspirating step is completed; and if not, step F2 is executed.

Aspirating step of the 2nd channel comprises the following steps:

G1. determining whether the status of the 2nd channel is Idle and executing step F3 if so, or executing aspirating step for the 3rd channel if not.

Aspirating step of the 3rd channel comprises the following step:

H1. determining whether the status of the 3rd channel is Idle, executing step F3 if so; or executing aspirating step for the 4th channel if not.

Aspirating step of the 4th channel comprises the following step:

I1. determining whether the status of the 4th channel is Idle, executing step F3 if so, or executing step F2 is not.

As a further improvement of the invention, sampling step comprises the following steps:

J1. determining whether the 1st channel has completed aspirating step, executing step J2 if so; or executing sampling step for the 2nd channel if not;

J2. sampling for the 1st channel;

J3. determining whether the required sampling times of the 1st channel on the item is achieved and executing step J4 if so, or executing sampling step the 2nd channel if not;

J4. performing data processing and result output on the corresponding channel;

J5. setting the status of the corresponding channel to Idle;

J6. determining whether all the samples have completed sampling step, if so, sampling step is completed; if not, step J1 is executed.

sampling step of the 2nd channel comprises the following steps:

K1. determining whether the 2nd channel has completed aspirating step, executing step k2 if so; or executing sampling step for the 3rd channel if not;

K2. sampling for the 2nd channel;

K3. determining whether the required sampling times of the 2nd channel on the item is achieved, executing step J4 if so, or executing sampling step the 3rd channel if not.

Sampling step of the 3rd channel comprises the following steps:

L1. determining whether the 3rd channel has completed aspirating step, executing step L2 if so, or executing sampling step the 3rd channel if not;

L2. sampling for the 3rd channel;

L3. determining whether the required sampling times of the 3rd channel on the item is achieved, executing step J4 if so, or executing sampling step the 4th channel if not.

Sampling step of the 4th channel comprises the following steps:

M1. determining whether the 4th channel has completed aspirating step, executing step M2 if so, or executing step J1 if not;

M2. sampling for the 4th channel;

M3. determining whether the required sampling times of the 4th channel on the item is achieved, executing step J4 if so, or executing step J1 if not.

As a further improvement of the invention, in step J2, whether the waiting time is reached after aspirating step the 1st channel is completed is determined, in which the 1st channel is subjected to sampling if so and Sampling step the 2nd channel is executed if not; in step K2, whether the waiting time is reached after aspirating step the 2nd channel is completed is determined, in which the 2nd channel is subjected to sampling if so and Sampling step the 3rd channel is executed if not; in step L2, whether the waiting time is reached after aspirating step the 3rd channel is completed is determined, in which the 3rd channel is subjected to sampling if so and Sampling step the 4th channel is executed if not; and in step M2, whether the waiting time is reached after aspirating step the 4th channel is completed is determined, in which the 4th channel is subjected to sampling if so and step J1 is executed if not.

As a further improvement of the invention, step F2 comprises the following steps:

F21. determining whether the 1st channel is closed, executing step F22 if not, or executing aspirating step the 2nd channel if so;

F22. determining whether the status of the 1st channel is Idle, executing step F3 if so, or executing aspirating step the 2nd channel if not.

Step G1 comprises the following steps:

G11. determining whether the 2nd channel is closed, executing step G12 if not, or executing aspirating step the 3rd channel if so;

G12. determining whether the status of the 2nd channel is Idle, executing step F3 if so, or executing aspirating step the 3rd channel if not.

Step H1 comprises the following steps:

H11. determining whether the 3rd channel is closed, executing step H12 if not, or executing aspirating step the 4th channel if so;

H12. determining whether the status of the 3rd channel is Idle, executing step F3 if so, or executing aspirating step the 4th channel if not.

Step H1 comprises the following steps:

H11. determining whether the 4th channel is closed, executing step I12 if not, or executing step F21 if so;

I12. determining whether the status of the 4th channel is Idle, executing step F3 if so, or executing step F21 if not.

As a further improvement of the invention, step A also comprises step of manually set the on-off state of the 1st channel, the 2nd channel, the 3rd channel and the 4th channel.

### BRIEF DESCRIPTION OF THE DRAWINGS

FIG. 1 is a method flowchart of the channel allocation control method for the multichannel biochemistry analyzer, provided by the invention;

FIG. 2 is a method flowchart of a 1st embodiment of aspirating step of the channel allocation control method for the multichannel biochemistry analyzer, provided by the invention;

FIG. 3 is a method flowchart of a 1st embodiment of sampling step of the channel allocation control method for the multichannel biochemistry analyzer, provided by the invention;

FIG. 4 is a flowchart of a method for determining whether all the sample items have completed aspirating step, of the channel allocation control method for the multichannel biochemistry analyzer, provided by the invention;

FIG. 5 is a flowchart of a method for determining whether all the sample items have completed sampling step, of the channel allocation control method for the multichannel biochemistry analyzer, provided by the invention;

FIG. 6 is a method flowchart of a 2nd embodiment of aspirating step of the channel allocation control method for the multichannel biochemistry analyzer, provided by the invention;

FIG. 7 is a method flowchart of a 2nd embodiment of sampling step of the channel allocation control method for the multichannel biochemistry analyzer, provided by the invention;

FIG. 8 is a method flowchart of a 3rd embodiment of aspirating step of the channel allocation control method for the multichannel biochemistry analyzer, provided by the invention.

### DETAILED DESCRIPTION OF THE PREFERRED EMBODIMENTS

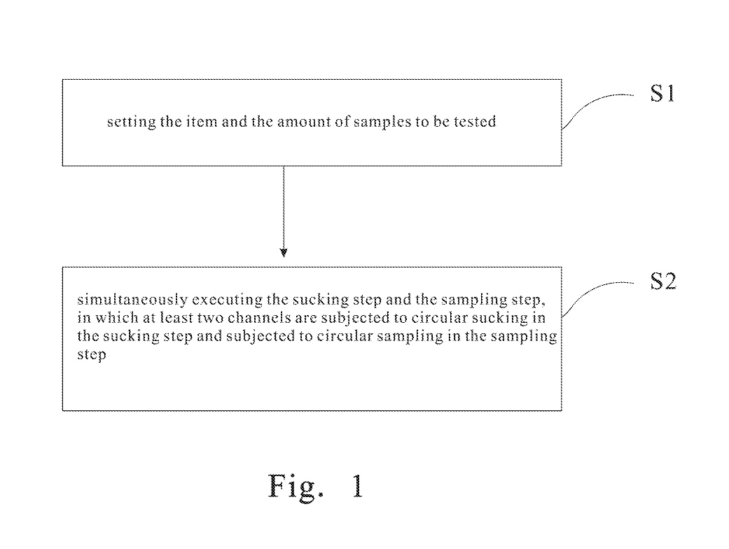

As illustrated in FIG. 1, the invention discloses a channel allocation control method for a multichannel biochemistry analyzer, which comprises the following steps:

Step S1: setting the item and the amount of samples to be tested. Step S2: simultaneously executing aspirating and sampling step, in which at least two channels are involved in circular aspirating in aspirating step and circular sampling in sampling step. In step S1, the item and the amount of the samples are manually set by a staff member on the biochemistry analyzer. As the entire test is decomposed into aspirating and sampling step and the circular aspirating and the circular sampling in the two steps are simultaneously and independently executed, not only the aim of testing a plurality of channels simultaneously can be realized and the testing efficiency can be improved but also the channel allocation can be performed automatically and different channels can be identified. Moreover, as aspirating and sampling step are executed independently and not affected by each other, the sample test can be completed by the collaboration of the two steps.

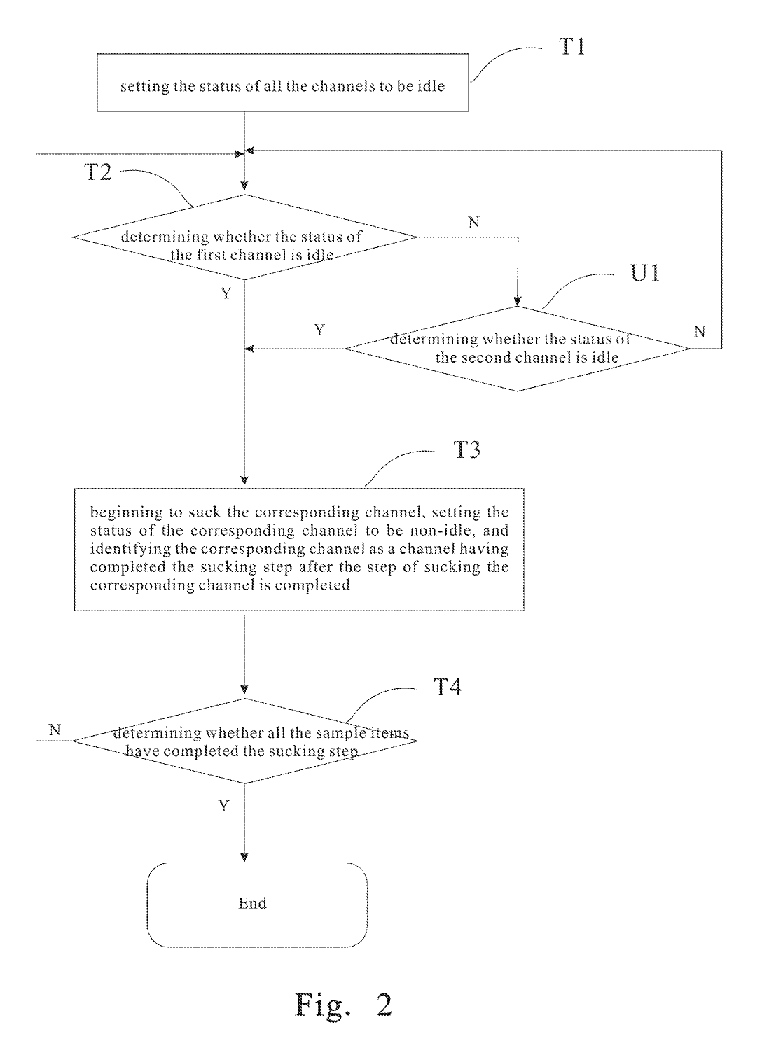

As illustrated in FIG. 2, the at least two channels are involved in (e.g. 1st channel and a 2nd channel), and aspirating step comprises the following steps:

Step T1: setting the status of all the channels to Idle. Step T2: determining whether the status of the 1st channel is Idle, executing step T3 if so, or executing aspirating step the 2nd channel if not. Step T3: starting to aspirate the corresponding channel, setting the status of the corresponding channel to Occupied, and identifying the corresponding channel as a channel having completed aspirating step after aspirating step the corresponding channel is completed. Step T4: determining whether all the sample items have completed aspirating step, in which if so, aspirating step is completed; and if not, step T2 is executed. Aspirating step the 2nd channel comprises the following step of: step U1: determining whether the status of the 2nd channel is Idle, executing step T3 if so, or executing step T2 if not.

For example, in step T2, step T3 is executed if the status of the 1st channel is [Idle]. In step T3, the 1st channel is subjected to aspirating; the status of the 1st channel is set to Occupied; and the 1st channel is identified as a channel having completed aspirating step after aspirating step the 1st channel is completed. In step T4, whether all the sample items have completed aspirating step is determined, in which aspirating step is completed if so and step T2 is executed if not. Herein, in step T2, step U1 is executed if the status of the 1st channel is Occupied; in step U1, step T3 is executed if the status of the 2nd channel is Idle; in step T3, the 2nd channel is subjected to aspirating; the status of the 2nd channel is set to Occupied; and the 2nd channel is identified as a channel having completed aspirating step after aspirating step the 2nd channel is completed; and then step T4 is executed. In step T4, step T2 is executed if not all the samples have completed aspirating step. Subsequently, step T2 is executed. Herein, in step T2, step U1 is executed if the status of the 1st channel is Occupied; and in step U1, step T2 is executed if the status of the 2nd channel is Occupied. Step T2 and U1 are executed circularly and step T3 is executed until the status of the 1st channel or the 2nd channel is Idle. Due to the execution of step T2 and U1, the automatic allocation of the channels is realized, so no channel is required to be determined for aspirating and an idle channel may be subjected to aspirating automatically, and thus the process is fast and the idle channel can be subjected to aspirating in the shortest time. Therefore, the waiting time of the idle channel can be shortened and the utilization rate of channel aspirating can be improved.

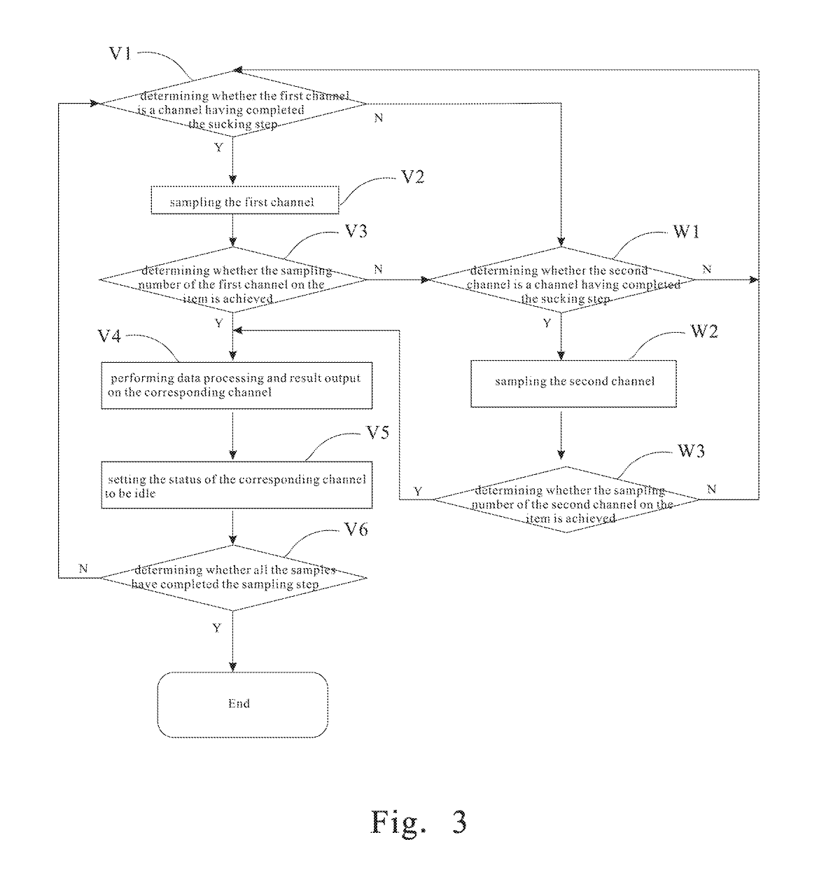

As illustrated in FIG. 3, sampling step comprises the following steps:

Step V1: determining whether the 1st channel has completed aspirating step, executing step V2 if so, or executing Sampling step the 2nd channel if not. Step V2: sampling the 1st channel. Step V3: determining whether the required sampling times of the 1st channel on the item is achieved, executing step D4 if so, or executing Sampling step the 2nd channel if not. Step V4: performing data processing and result output on the corresponding channel. Step V5: setting the status of the corresponding channel to Idle. Step V6: determining whether all the samples have completed sampling step, in which if so, sampling step is completed; and if not, step V1 is executed.

Sampling step the 2nd channel comprises the following steps:

Step W1: determining whether the 2nd channel has completed aspirating step, executing step W2 if so, or executing step V1 if not. Step W2: sampling for the 2nd channel. Step W3: determining whether the required sampling times of the 2nd channel on the item is achieved, executing step D4 if so, or executing step D1 if not.

Whether the 1st channel has completed aspirating step in step V1 is determined according to the result in step T3 that the corresponding channel is identified as a channel having completed aspirating step. Whether the 2nd channel has completed aspirating step in step W1 is also determined according to the result in step T3 that the corresponding channel is identified as a channel having completed aspirating step.

For example, in step V1, step V2 is executed if the 1st channel has completed aspirating step. In step V2, the 1st channel is subjected to sampling. In step V3, step V4 is executed if the required sampling times of the 1st channel on the item is achieved. In step V4, the 1st channel is subjected to data processing and result output. In step V5, the status of the 1st channel is set to Idle. In step V6, step V1 is executed if not all the samples have completed sampling step. As the status of the 1st channel is set to Idle in step V5, the 1st channel may be subjected to aspirating continuously in aspirating step and herein is not identified as a channel having completed aspirating step and can only be identified as a channel having completed aspirating step until step T3 is executed. After step V6, step V1 is executed continuously. In step V1, Sampling step the 2nd channel is executed if the 1st channel is not a channel having completed aspirating step. In step W1, step W2 is executed if the 2nd channel is not a channel having completed aspirating step. In step W2, the 2nd channel is subjected to sampling. In step W3, step V4 is executed if the required sampling times of the 2nd channel on the item is achieved. In step V4, the 2nd channel is subjected to data processing and result output. In step V5, the status of the 2nd channel is set to Idle. In step V6, whether all the samples have completed sampling step is determined, in which if so, sampling step is completed; and if not, step V1 is executed.

Aspirating and sampling step not only are executed independently and not affected by each other but also are interrelated via the set and conversion of the channel status and collaborated with each other to complete the sample test. Therefore, the channels are always in the processes of aspirating and sampling, and thus the sample test speed can be accelerated. For the maximum utilization of channel sampling, in step V3, sampling step the 2nd channel is executed if the required sampling times of the 1st channel on the item is not achieved. Sampling of the 1st channel is realized via step V3. Moreover, sampling step the 2nd channel is executed if the required sampling times of the 1st channel on the item is not achieved. Therefore, the 1st channel and the 2nd channel complete sampling step together and the two tasks do not affect each other, and thus the conversion waiting time between the channels can be reduced and the working efficiency can be improved.

In step V2, whether the waiting time is reached after aspirating step the 1st channel is completed is determined, in which if so, the 1st channel is subjected to sampling; and if not, sampling step the 2nd channel is executed. In step W2, whether the waiting time is reached after aspirating step the 2nd channel is completed is determined, in which if so, the 2nd channel is subjected to sampling; and if not, step V1 is executed.

The waiting time in the invention can be the set time set in the biochemistry analyzer and can also be the time manually set by a staff member before the sample test.

For example, the waiting time is set to be 6 seconds, and then in step V2, the 1st channel is subjected to sampling if the waiting time is more than 6 seconds after aspirating step the 1st channel is completed and Sampling step the 2nd channel is executed if the waiting time is not more than 6 seconds after aspirating step the 1st channel is completed. As the sample response speed calculated is different and the test time of different items is different as well, sampling step can only be executed after waiting for a period of time when aspirating step is completed, and then the accuracy of the sample test can be better guaranteed.

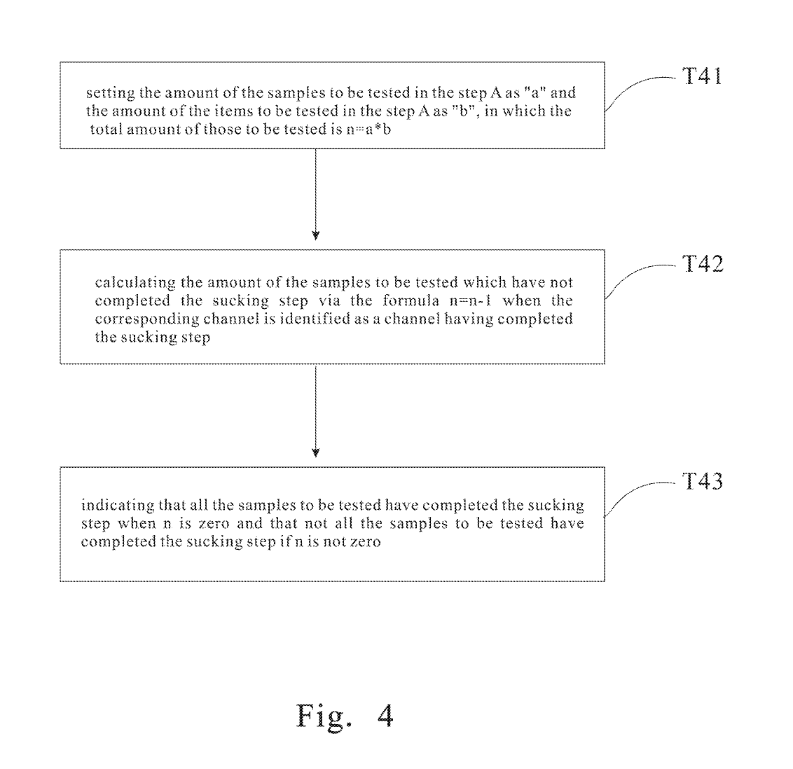

As illustrated in FIG. 4, in step T4, the step for determining whether all the sample items have completed aspirating step comprises the following steps:

Step T41: setting the amount of the samples to be tested in step A as “a” and the amount of the items to be tested in step A as “b”, in which the total amount of those to be tested is n=a*b. Step T42: calculating the amount of the samples to be tested which have not completed aspirating step via the formula n=n−1 when the corresponding channel is identified as a channel having completed aspirating step. Step T43: indicating that all the samples to be tested have completed aspirating step when n is zero and that not all the samples to be tested have completed aspirating step if n is not zero.

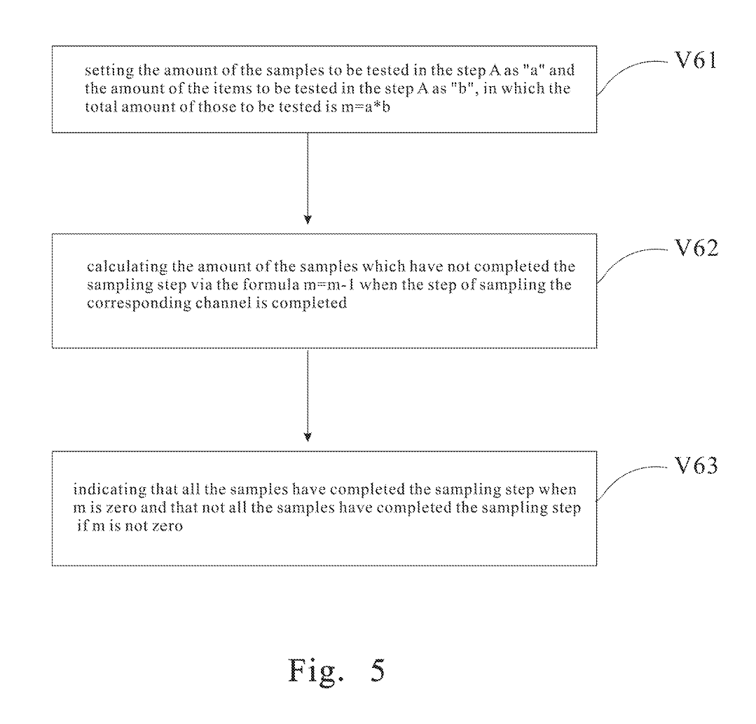

As illustrated in FIG. 5, in step V6, the step for determining whether all the samples have completed sampling step comprises the following steps:

step V61: setting the amount of the samples to be tested in step A as “a” and the amount of the items to be tested in step A as “b”, in which the total amount of those to be tested is m=a*b. Step V62: calculating the amount of the samples which have not completed sampling step via the formula m=m−1 when Sampling step the corresponding channel is completed. Step V63: indicating that all the samples have completed sampling step when m is zero and that not all the samples have completed sampling step if m is not zero.

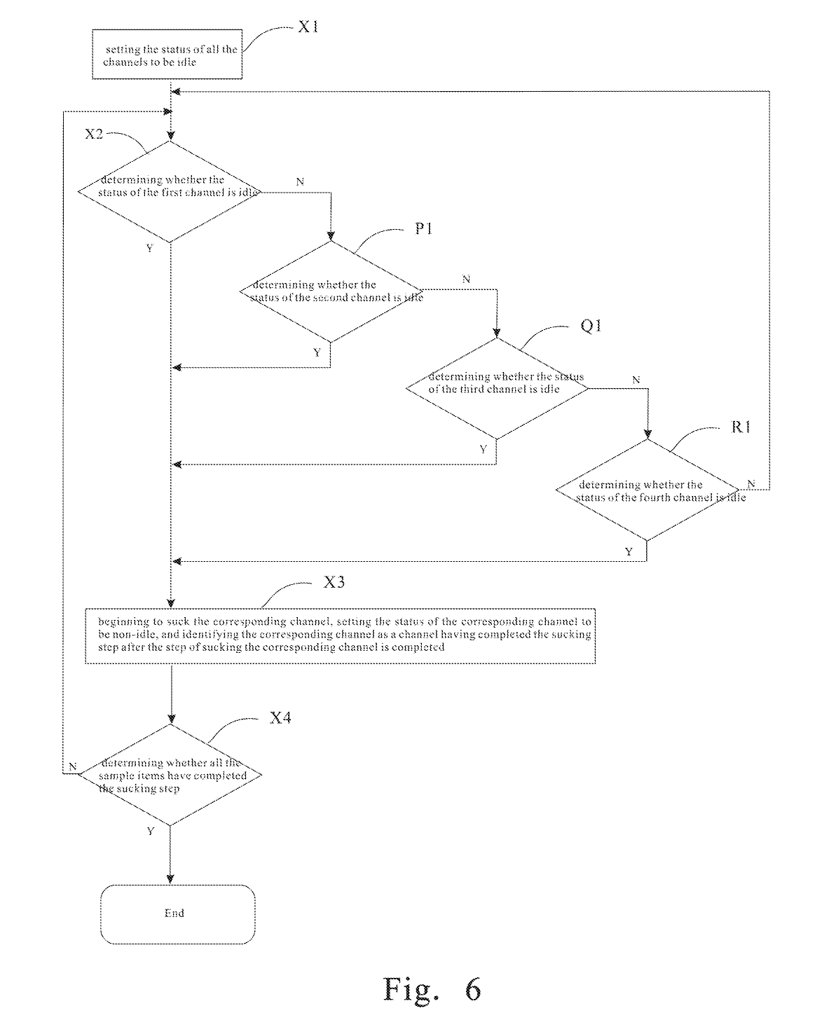

As illustrated in FIG. 6, the number of the channels is four and the four channels are a 1st channel, a 2nd channel, a 3rd channel and a 4th channel respectively. Aspirating step comprises the following steps:

Step X1: setting the status of all the channels to be Idle. Step X2: determining whether the status of the 1st channel is Idle, executing step X3 if so, or executing aspirating step the 2nd channel if not. Step X3: starting to aspirate the corresponding channel, setting the status of the corresponding channel to Occupied, and identifying the corresponding channel as a channel having completed aspirating step after aspirating step the corresponding channel is completed. Step X4: determining whether all the sample items have completed aspirating step, in which if so, aspirating step is completed; and if not, step X2 is executed.

Aspirating step of the 2nd channel comprises the following step: step P1: determining whether the status of the 2nd channel is Idle, executing step X3 if so, or executing aspirating step the 3rd channel if not.

Aspirating step the 3rd channel comprises the following step of: step Q1: determining whether the status of the 3rd channel is Idle, executing step X3 if so, or executing aspirating step the 4th channel if not.

Aspirating step the 4th channel comprises the following step of: step R1: determining whether the status of the 4th channel is Idle, executing step X3 if so, or executing step X2 if not.

As two channels are added in the embodiment on the basis of the 1st embodiment of aspirating step, the automatic allocation of the channels can be realized, and thus no channel is required to be determined for aspirating and an idle channel may be subjected to aspirating automatically, and consequently the process is fast and the idle channel can be subjected to aspirating in the shortest time. Therefore, the waiting time of the idle channel can be shortened and the utilization rate of channel aspirating can be improved. Moreover, as the four channels are subjected to circular aspirating, aspirating speed can be further accelerated.

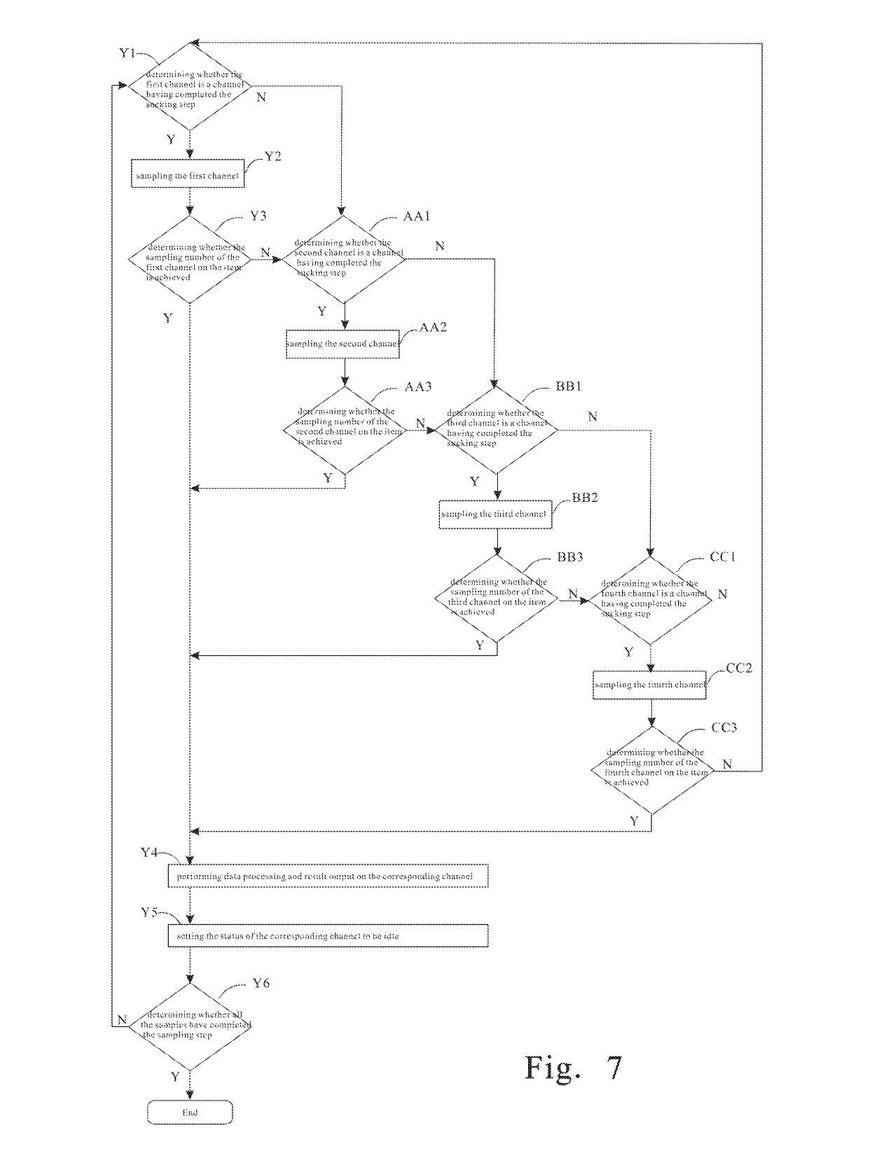

As illustrated in FIG. 7, sampling step comprises the following steps:

Step Y1: determining whether the 1st channel has completed aspirating step, executing step Y2 if so, or executing step of sampling the 2nd channel if not. Step Y2: sampling the 1st channel. Step Y3: determining whether the required sampling times of the 1st channel on the item is achieved, executing step J4 if so, or executing sampling step the 2nd channel if not. Step Y4: performing data processing and result output on the corresponding channel. Step Y5: setting the status of the corresponding channel to Idle. Step Y6: determining whether all the samples have completed sampling step, in which if not, sampling step is completed; and if not, step Y1 is executed.

Sampling step the 2nd channel comprises the following steps:

Step AA1: determining whether the 2nd channel has completed aspirating step, executing step AA2 if so, or executing Sampling step the 3rd channel if not. Step AA2: sampling the 2nd channel. Step AA3: determining whether the required sampling times of the 2nd channel on the item is achieved, executing step J4 if so, or executing sampling step the 3rd channel if not.

Sampling step the 3rd channel comprises the following steps:

Step BB1: determining whether the 3rd channel has completed aspirating step, executing step BB2 if so, or executing sampling step the 4th channel if not. Step BB2: sampling the 3rd channel. Step BB3: determining whether the required sampling times of the 3rd channel on the item is achieved, executing step J4 if so, or executing Sampling step the 4th channel if not.

Sampling step the 4th channel comprises the following steps:

Step CC1: determining whether the 4th channel has completed aspirating step, executing step CC2 if so, or executing step Y1 if not. Step CC2: sampling the 4th channel. Step CC3: determining whether the required sampling times of the 4th channel on the item is achieved, executing step J4 if so, or executing step J1 if not.

In step Y2, whether the waiting time is reached after aspirating step the 1st channel is completed is determined, in which if so, the 1st channel is subjected to sampling; and if not, Sampling step the 2nd channel is executed. In step AA2, whether the waiting time is reached after aspirating step the 2nd channel is completed is determined, in which if so, the 2nd channel is subjected to sampling; and if not, Sampling step the 3rd channel is executed. In step BB2, whether the waiting time is reached after aspirating step the 3rd channel is completed is determined, in which if so, the 3rd channel is subjected to sampling; and if not, Sampling step the 4th channel is executed. In step CC2, whether the waiting time is reached after aspirating step the 4th channel is completed is determined, in which if so, the 4th channel is executed; and if not, step Y1 is executed.

As two channels are added in the embodiment on the basis of the 1st embodiment of sampling step and the four channels are subjected to circular sampling, sampling speed can be further accelerated.

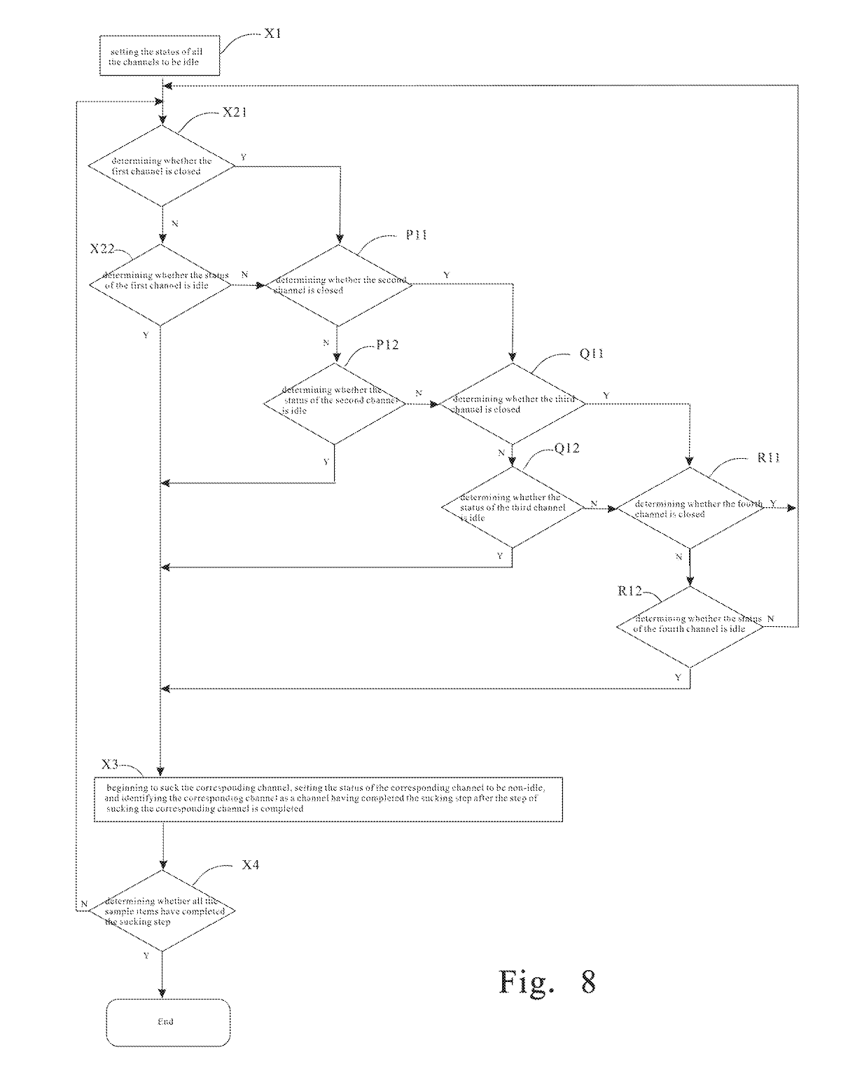

As illustrated in FIG. 8, Step X2 comprises the following steps:

Step X21: determining whether the 1st channel is closed, executing step X22 if not, or executing aspirating step the 2nd channel if so. Step X22: determining whether the status of the 1st channel is Idle, executing step X3 if so, or executing aspirating step the 2nd channel if not.

Step P1 comprises the following steps:

Step P11: determining whether the 2nd channel is closed, executing step P12 if not, or executing aspirating step the 3rd channel if so. Step P12: determining whether the status of the 2nd channel is Idle, executing step X3 if so, or executing aspirating step the 3rd channel if not.

Step Q1 comprises the following steps:

Step Q11: determining whether the 3rd channel is closed, executing step Q12 if not, or executing aspirating step the 4th channel if so. Step Q12: determining whether the status of the 3rd channel is Idle, executing step X3 if so, or executing aspirating step the 4th channel if not.

Step R1 comprises the following steps:

Step R11: determining whether the 4th channel is closed, executing step R12 if not, or executing step X21 if so. Step R12: determining whether the status of the 4th channel is Idle, executing step X3 if so, or executing step X21 if not.

Step A also comprises the step of manually setting the on-off state of the 1st channel, the 2nd channel, the 3rd channel and the 4th channel. As some sample tests do not need a plurality of channels and some only need three channels, three channels can be manually opened and one channel can be manually closed by a staff member in step A. The opening of appropriate number of channels is favorable for improving the speed of sample test.

The method provided by the invention can be realized via the collaboration of computer software and the biochemistry analyzer.

The above is only further detailed description of the invention with the preferred embodiments. It shall not be determined that the specific implementation of the invention be only limited by the description. Various simple deductions or replacements can be made by those skilled in the art without departing from the concept of the invention and shall be all within the scope of protection of the invention.

1. A channel allocation control method for a multichannel biochemistry analyzer, comprising the following steps:
a) setting the item and the amount of samples to be tested;
b) simultaneously executing aspirating and sampling step, in which at least two channels are involved in circular aspirating in aspirating step and circular sampling in sampling step.

2. The channel allocation control method according to claim 1, wherein at least two channels are a 1st channel and a 2nd channel, and aspirating step comprises the following steps:
b1) setting the status of all the channels to Idle;
b2) determining whether the status of the 1st channel is Idle, executing step b3) if so, or executing aspirating step the 2nd channel if not;
b3) starting to aspirate the corresponding channel, setting the status of the corresponding channel to Occupied, and identifying the corresponding channel as a channel having completed aspirating step after aspirating step the corresponding channel is completed;
b4) determining whether all the sample items have completed aspirating step, in which if so, aspirating step is completed; and if not, step b2) is executed;
aspirating step the 2nd channel comprises the following step:
c1) determining whether the status of the 2nd channel is Idle, executing step b3) if so, or executing step b2) if not.

3. The channel allocation control method according to claim 2, wherein sampling step comprises the following steps:
d1) determining whether the 1st channel has completed aspirating step, executing step d2) if so, or executing sampling step the 2nd channel if not;
d2) sampling for the 1st channel;
d3) determining whether the required sampling times of the 1st channel on the item is achieved, executing step d4) if so, or executing sampling step the 2nd channel if not;
d4) performing data processing and result output on the corresponding channel;
d5) setting the status of the corresponding channel to Idle;
d6) determining whether all the samples have completed sampling step, in which if so, sampling step is completed; and if not, step d1) is executed;
sampling step the 2nd channel comprises the following steps:
e1) determining whether the 2nd channel has completed aspirating step, executing step e2) if so, or executing step d1) if not;
e2) sampling the 2nd channel;
e3) determining whether the required sampling times of the 2nd channel on the item is achieved, executing step d4) if so, or executing step d1) if not.

4. The channel allocation control method according to claim 3, wherein in step d2), whether the waiting time is reached after aspirating step the 1st channel is completed is determined, in which the 1st channel is subjected to sampling if so and sampling step the 2nd channel is executed if not; and in step e2), whether the waiting time is reached after aspirating step the 2nd channel is completed is determined, in which the 2nd channel is subjected to sampling if so and step d1) is executed if not.

5. The channel allocation control method according to claim 4, wherein in step b4), the step for determining whether all the sample items have completed aspirating step comprises the following steps:
b41) setting the amount of the samples to be tested in step A as “a” and the amount of the items to be tested in step A as “b”, in which the total amount of those to be tested is n=a*b;
b42) calculating the amount of the samples to be tested which have not completed aspirating step via the formula n=n−1 when the corresponding channel is identified as a channel having completed aspirating step;
b43) indicating that all the samples to be tested have completed aspirating step when n is zero and that not all the samples to be tested have completed aspirating step if n is not zero;
in step d6), the step for determining whether all the samples have completed sampling step comprises the following steps:
d61) setting the amount of the samples to be tested in step A as “a” and the amount of the items to be tested in step A as “b”, in which the total amount of those to be tested is m=a*b;
d62) calculating the amount of the samples to be tested which have not completed sampling step when the corresponding channel has completed sampling step;
d63) indicating that all the samples have completed sampling step when m is zero and that not all the samples have completed sampling step if m is not zero.

6. The channel allocation control method according to claim 1, wherein the number of the channels is four and the four channels are a 1st channel, a 2nd channel, a 3rd channel and a 4th channel respectively; and aspirating step comprises the following steps:
f1) setting the status of all the channels to Idle;
f2) determining whether the status of the 1st channel is Idle, executing step f3) if so, or executing aspirating step the 2nd channel if not;
f3) starting to aspirate the corresponding channel, setting the status of the corresponding channel to Occupied, and identifying the corresponding channel as a channel having completed aspirating step after aspirating step the corresponding channel is completed;
f4) determining whether all the sample items have completed aspirating step, in which if so, aspirating step is completed; and if not, step f2) is executed;
aspirating step the 2nd channel comprises the following step:
g1) determining whether the status of the 2nd channel is Idle, executing step f3) if so, or executing aspirating step the 3rd channel if not;
aspirating step the 3rd channel comprises the following step:
h1) determining whether the status of the 3rd channel is Idle, executing step f3) if so, or executing aspirating step the 4th channel if not;
aspirating step the 4th channel comprises the following step:
i1) determining whether the status of the 4th channel is Idle, executing step f3) if so, or executing step f2) if not.

7. The channel allocation control method according to claim 6, wherein sampling step comprises the following steps:
j1) determining whether the 1st channel has completed aspirating step, executing step j2) if so, or executing sampling step the 2nd channel if not;
j2) carrying out sampling for the 1st channel;
i3. determining whether the required sampling times of the 1st channel on the item is achieved, executing step j4) if so, or executing sampling step the 2nd channel if not;
j4) performing data processing and result output on the corresponding channel;
j5) setting the status of the corresponding channel to be Idle;
j6) determining whether all the samples have completed sampling step, in which if so, sampling step is completed; and if not, step j1) is executed;
sampling step the 2nd channel comprises the following steps:
k1) determining whether the 2nd channel has completed aspirating, executing step k2) if so, or executing sampling step the 3rd channel if not;
k2) carrying out sampling for the 2nd channel;
k3) determining whether the required sampling times of the 2nd channel on the item is achieved, executing step j4) if so, or executing sampling step the 3rd channel if not;
sampling step the 3rd channel comprises the following steps:
l1) determining whether the 3rd channel has completed aspirating step, executing step l2) if so, or executing sampling step the 3rd channel if not;
12) sampling the 3rd channel; and
13) determining whether the required sampling times of the 3rd channel on the item is achieved, executing step j4) if so, or executing sampling step the 4th channel if not;
sampling step the 4th channel comprises the following steps:
m1) determining whether the 4th channel has completed aspirating step,
executing step m2) if so, or executing step j1) if not;
m2) sampling the 4th channel; and
m3) determining whether the required sampling times of the 4th channel on the item is achieved, executing step j4) if so, or executing step j1) if not.

8. The channel allocation control method according to claim 7, wherein in step j2), whether the waiting time is reached after aspirating step the 1st channel is completed is determined, in which the 1st channel is subjected to sampling if so and sampling step the 2nd channel is executed if not; in step k2), whether the waiting time is reached after aspirating step the 2nd channel is completed is determined, in which the 2nd channel is subjected to sampling if so and sampling step the 3rd channel is executed if not; in step l2), whether the waiting time is reached after aspirating step the 3rd channel is completed is determined, in which the 3rd channel is subjected to sampling if so and sampling step the 4th channel is executed if not; and in step m2), whether the waiting time is reached after aspirating step the 4th channel is completed is determined, in which the 4th channel is subjected to sampling if so and step j1) is executed if not.

9. The channel allocation control method according to claim 6, wherein step f2) comprises the following steps:
f21) determining whether the 1st channel is closed, executing step f22) if not, or executing aspirating step the 2nd channel if so;
f22) determining whether the status of the 1st channel is Idle, executing step f3) if so, or executing aspirating step the 2nd channel if not;
step g1) comprises the following steps:
g11) determining whether the 2nd channel is closed, executing step g12) if not, or executing aspirating step the 3rd channel if so;
g12) determining whether the status of the 2nd channel is Idle, executing step f3) if so, or executing aspirating step the 3rd channel if not;
step h1) comprises the following steps:
h11) determining whether the 3rd channel is closed, executing step h12) if not, or executing aspirating step the 4th channel if so;
h12) determining whether the status of the 3rd channel is Idle, executing step f3) if so, or executing aspirating step the 4th channel if not;
step i1) comprises the following steps:
i11) determining whether the 4th channel is closed, executing step i12) if not, or executing step f21) if so;
i12) determine whether the status of the 4th channel is Idle, executing step f3) if so, or executing step f21) if not.

10. The channel allocation control method according to claim 9, wherein step a) also comprises step of manually setting the on-off state of the 1st channel, the 2nd channel, the 3rd channel and the 4th channel.

11. The channel allocation control method according to claim 7, wherein step f2) comprises the following steps:
f21) determining whether the 1st channel is closed, executing step f22) if not, or executing aspirating step the 2nd channel if so;
f22) determining whether the status of the 1st channel is Idle, executing step f3) if so, or executing aspirating step the 2nd channel if not;
step g1) comprises the following steps:
g11) determining whether the 2nd channel is closed, executing step g12) if not, or executing aspirating step the 3rd channel if so;
g12) determining whether the status of the 2nd channel is Idle, executing step f3) if so, or executing aspirating step the 3rd channel if not;
step h1) comprises the following steps:
h11) determining whether the 3rd channel is closed, executing step h12) if not, or executing aspirating step the 4th channel if so;
h12) determining whether the status of the 3rd channel is Idle, executing step f3) if so, or executing aspirating step the 4th channel if not;
step i1) comprises the following steps:
i11) determining whether the 4th channel is closed, executing step i12) if not, or executing step f21) if so;
i12) determine whether the status of the 4th channel is Idle, executing step f3) if so, or executing step f21) if not.

12. The channel allocation control method according to claim 11, wherein step a) also comprises step of manually setting the on-off state of the 1st channel, the 2nd channel, the 3rd channel and the 4th channel.

13. The channel allocation control method according to claim 8, wherein step f2) comprises the following steps:
f21) determining whether the 1st channel is closed, executing step f22) if not, or executing aspirating step the 2nd channel if so;
f22) determining whether the status of the 1st channel is Idle, executing step f3) if so, or executing aspirating step the 2nd channel if not;
step g1) comprises the following steps:
g11) determining whether the 2nd channel is closed, executing step g12) if not, or executing aspirating step the 3rd channel if so;
g12) determining whether the status of the 2nd channel is Idle, executing step f3) if so, or executing aspirating step the 3rd channel if not;
step h1) comprises the following steps:
h11) determining whether the 3rd channel is closed, executing step h12) if not, or executing aspirating step the 4th channel if so;
h12) determining whether the status of the 3rd channel is Idle, executing step f3) if so, or executing aspirating step the 4th channel if not;
step i1) comprises the following steps:
i11) determining whether the 4th channel is closed, executing step i12) if not, or executing step f21) if so;
i12) determine whether the status of the 4th channel is Idle, executing step f3) if so, or executing step f21) if not.

14. The channel allocation control method according to claim 13, wherein step a) also comprises step of manually setting the on-off state of the 1st channel, the 2nd channel, the 3rd channel and the 4th channel.
